(19) United States
(12) Patent Application Publication
(10) Pub. No.: US 2009/0049390 A1
(43) Pub. Date: Feb. 19, 2009

(54) Methods and apparatuses for distributing content based on profile information and rating the content

(75) Inventors: Benbuck Nason, Castro Valley, CA (US); Jay Carlson, Foster City, CA (US); Klaus Hofrichter, Menlo Park, CA (US); Gary Zalewski, Oakland, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment Inc.

(21) Appl. No.: 11/893,729

(22) Filed: Aug. 17, 2007

(51) Int. Cl. G06F 3/00

(52) U.S. Cl. 715/747

(57) ABSTRACT

In one embodiment, the methods and apparatuses detect content and content information wherein the content information is related to the content; detect a user and user information wherein the user information is related to the user; match the content information with the user information; select the user based on the matching; detect a user input based on the user utilizing the content; and modify the user information and the content information based on the user input.

### FIELD OF THE INVENTION

The present invention relates generally to distributing content and rating content and, more particularly, to distributing content based on profile information and rating the content.

### BACKGROUND

Content may include advertisements and programming materials such as television shows, video clips, movies, music, podcasts, radio shows, web pages, documents, and the like. People often view advertisements along with programming materials. For example, people typically watch commercials along with television programs. In another instance, people may also view advertisements while viewing websites. Further, people also often listen to advertisements while listening to the radio.

In some instances, the advertisements are integrated within the programming materials

When the content is not targeted to match the interests of the viewers, then the viewers may lose interest utilizing the content. Further, by not utilizing the content, the advertisements whether distinct from the programming materials or integrated with the programming materials are not utilized by the viewers.

### SUMMARY

In one embodiment, the methods and apparatuses detect content and content information wherein the content information is related to the content; detect a user and user information wherein the user information is related to the user; match the content information with the user information; select the user based on the matching; detect a user input based on the user utilizing the content; and modify the user information and the content information based on the user input.

### BRIEF DESCRIPTION OF THE DRAWINGS

The accompanying drawings, which are incorporated in and constitute a part of this specification, illustrate and explain one embodiment of the methods and apparatuses for distributing content based on profile information and rating the content. In the drawings,

FIG. 1 is a diagram illustrating an environment within which the methods and apparatuses for distributing content based on profile information and rating the content are implemented;

FIG. 2 is a simplified block diagram illustrating one embodiment in which the methods and apparatuses for distributing content based on profile information and rating the content are implemented;

FIG. 3 is a simplified block diagram illustrating a system, consistent with one embodiment of the methods and apparatuses for distributing content based on profile information and rating the content;

FIG. 4a illustrates an exemplary record consistent with one embodiment of the methods and apparatuses for distributing content based on profile information and rating the content;

FIG. 4b illustrates an exemplary record consistent with one embodiment of the methods and apparatuses for distributing content based on profile information and rating the content;

FIG. 5 is a flow diagram consistent with one embodiment of the methods and apparatuses for distributing content based on profile information and rating the content; and

FIG. 6 illustrates an exemplary portion of content consistent with one embodiment of the methods and apparatuses for distributing content based on profile information and rating the content.

### DETAILED DESCRIPTION

The following detailed description of the methods and apparatuses for distributing content based on profile information and rating the content refers to the accompanying drawings. The detailed description is not intended to limit the methods and apparatuses for distributing content based on profile information and rating the content.

Instead, the scope of the methods and apparatuses for distributing content based on profile information and rating the content is defined by the appended claims and equivalents. Those skilled in the art will recognize that many other implementations are possible, consistent with the methods and apparatuses for distributing content based on profile information and rating the content.

References to “electronic device” include a device such as a personal digital video recorder, digital audio player, gaming console, a set top box, a radio, a television, a personal computer, a cellular telephone, a personal digital assistant, a specialized computer such as an electronic interface with an automobile, and the like.

References to “user” include an operator of electronic devices.

References to “content” include audio streams, images, video streams, photographs, graphical displays, text files, software applications, electronic messages, and the like. In another embodiment, “content” also refers to advertisements and programming.

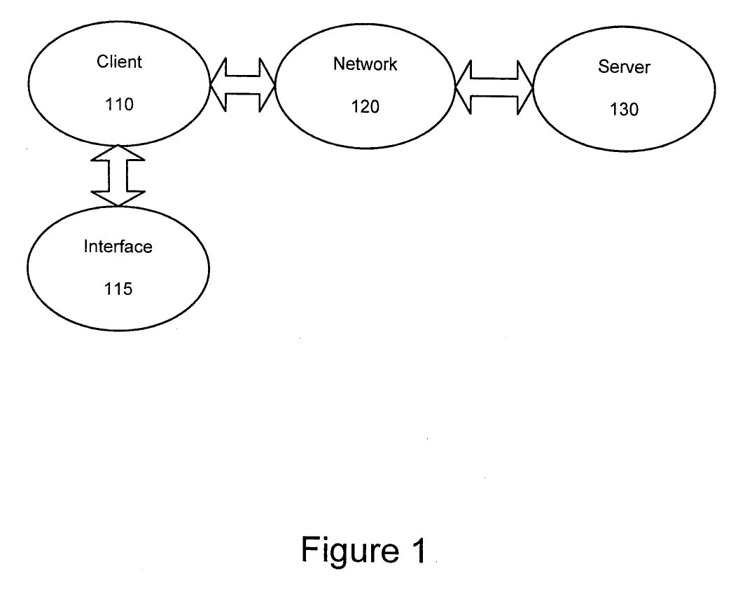

FIG. 1 is a diagram illustrating an environment within which the methods and apparatuses for distributing content based on profile information and rating the content are implemented. The environment includes an electronic device 110 (e.g., a computing platform configured to act as a client device, such as a personal digital video recorder, digital audio player, computer, a personal digital assistant, a cellular telephone, a camera device, a set top box, a gaming console), a user interface 115, a network 120 (e.g., a local area network, a home network, the Internet), and a server 130 (e.g., a computing platform configured to act as a server). In one embodiment, the network 120 can be implemented via wireless or wired solutions.

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device such as a mouse and trackball, a microphone, a speaker, a display, a camera) are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments for distributing content based on profile information and rating the content as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

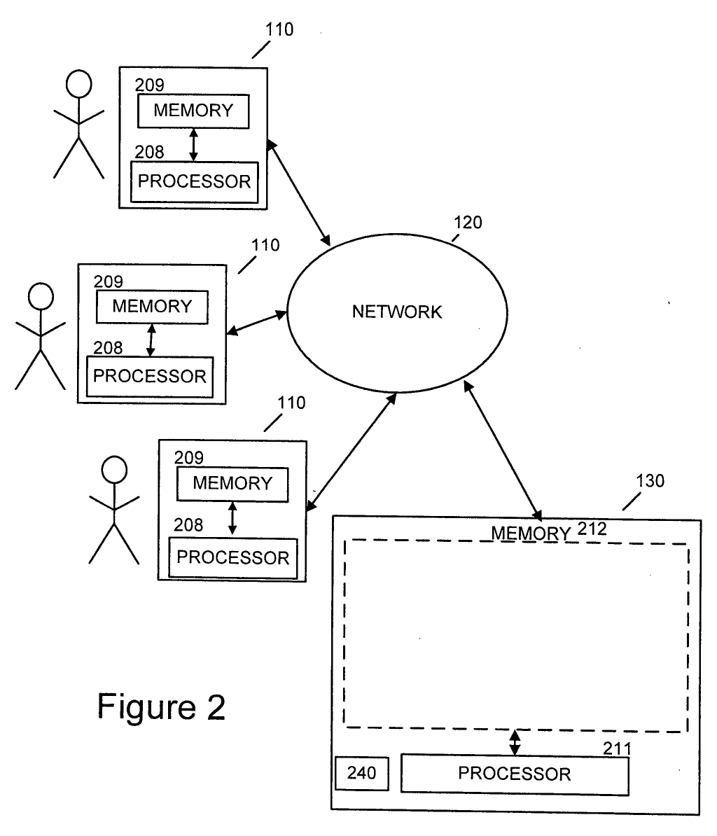

FIG. 2 is a simplified diagram illustrating an exemplary architecture in which the methods and apparatuses for distributing content based on profile information and rating the content are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application for distributing content based on profile information and rating the content. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on distributing content based on profile information and rating the content as determined using embodiments described below.

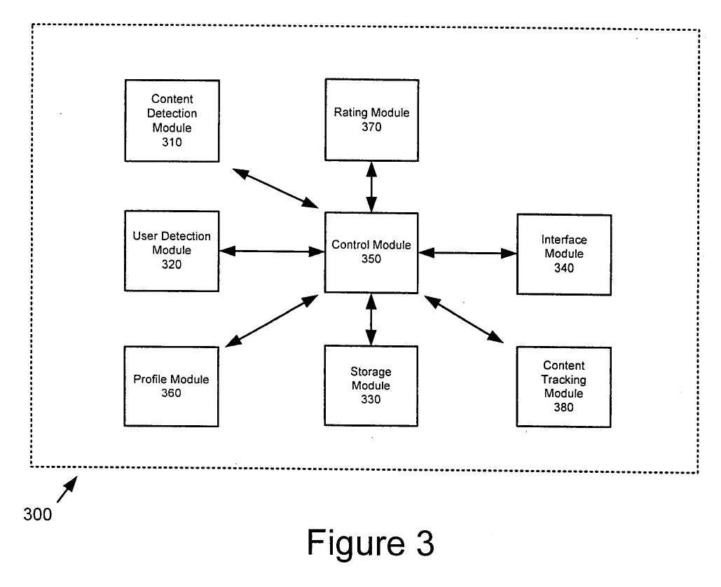

FIG. 3 illustrates one embodiment of a system 300 for distributing content based on profile information and rating the content. The system 300 includes a content detection module 310, a viewer module 320, a storage module 330, an interface module 340, a control module 350, a profile module 360, a rating module 370, and a content tracking module 380.

In one embodiment, the control module 350 communicates with the content detection module 310, the viewer module 320, the storage module 330, the interface module 340, the control module 350, the profile module 360, the rating module 370, and the content tracking module 380.

In one embodiment, the control module 350 coordinates tasks, requests, and communications between the content detection module 310, the viewer module 320, the storage module 330, the interface module 340, the control module 350, the profile module 360, the rating module 370, and the content tracking module 380.

In one embodiment, the content detection module 310 detects content such as images, text, graphics, video, audio, and the like. In one embodiment, the content detection module 310 is configured to uniquely identify the content. In one embodiment, the content includes television shows, music, advertisement, articles, books, and the like.

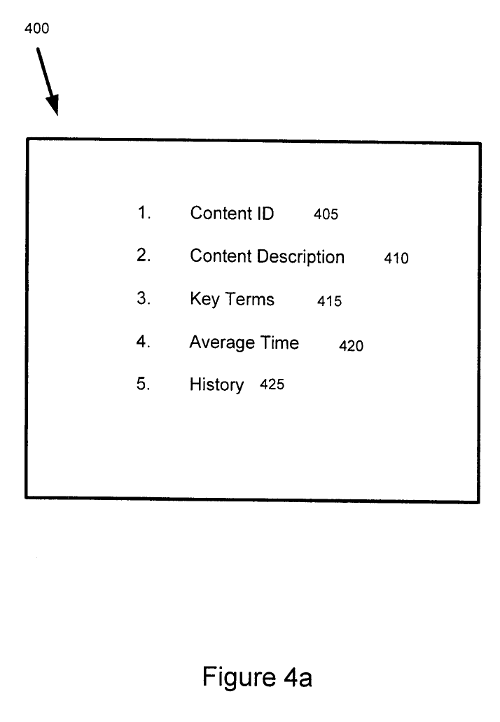

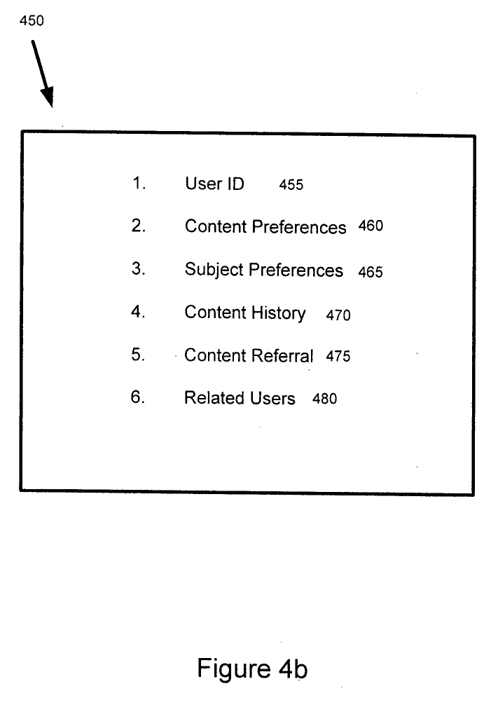

In addition to detecting the content, the content detection module 310 detects information related to the content. In one embodiment, information related to the content may include title of the content, content type, key terms describing the content, and the like. Further, information related to the content may be stored within profile information as shown in FIG. 4a. In one embodiment, the profile information is stored within the storage module 330. In another embodiment, the profile information is embedded within the metadata corresponding with the content.

In one embodiment, the viewer detection module 320 detects the viewer or user of the content. In one embodiment, the viewer detection module 320 detects the identity of the viewer through a log-in by the viewer. In another embodiment, the viewer detection module 320 detects the identity of the viewer through the specific electronic device accessing the content. In one embodiment, information related to the viewer of the content may be stored within profile information as shown in FIG. 4b.

In one embodiment, the viewer detection module 320 detects actions of the user while utilizing the content. In one embodiment, these actions by the user indicate whether the user likes or dislikes the content.

In one embodiment, the amount of time that the user spends utilizing the content is detected. For example, if the user spends a large amount of time utilizing the content, then this may indicate that the user enjoys the content and favorably rates this content.

In another embodiment, an input provided by the user regarding the content is also detected. For example, the user may provide a qualitative rating of the content through a keyboard or pointing device to rate the content. For example, the user may indicate with a “thumbs up” or “thumbs down” indicator to reflect the user's like or dislike of the content. In another example, the user can rate the content using a scale of 1-10.

In yet another embodiment, laughter or other emotion may be audibly captured of the user through a microphone while utilizing the content. In yet another example, smiles, frowns or other emotions may be visually captured of the user through a camera while utilizing the content. In one embodiment, laughter or smiles by the user indicates that the user enjoys the content and favorably rates the content.

In one embodiment, the storage module 330 stores a plurality of profiles wherein each profile is associated with various content and other data associated with the content or a viewer. In one embodiment, the profile stores exemplary information as shown in profiles illustrated in FIGS. 4a and 4b. In one embodiment, the storage module 330 is located within the server device 130. In another embodiment, portions of the storage module 330 are located within the electronic device 110.

In one embodiment, the interface module 340 detects the electronic device 110 as the electronic device 110 is connected to the network 120.

In another embodiment, the interface module 340 detects input from the interface device 115 such as a keyboard, a mouse, a microphone, a still camera, a video camera, and the like.

In yet another embodiment, the interface module 340 provides output to the interface device 115 such as a display, speakers, external storage devices, an external network, and the like.

In one embodiment, the profile module 360 processes profile information related to the specific content and each specific viewer. In one embodiment, exemplary profile information is shown within a record illustrated in FIGS. 4a and 4b. In one embodiment, each profile corresponds with a particular content. In another embodiment, each profile corresponds with a particular viewer or user.

In one embodiment, the rating module 370 determines a match between the content and the viewer. In one embodiment, the match between the content and the viewer are determined by a match between the attributes associated with the content and the viewer. In one embodiment, the information within the profiles of the content and the viewer are utilized to determine the match. Based on the match between the content and the viewer, the content is selectively distributed to the viewer for use by the viewer.

In one embodiment, the content tracking module 380 detects the delivery to content to various viewers. In one embodiment, content tracking module 380 also tracks the amount of time spent on viewing the content by the various viewers.

In one embodiment, the system 300 is configured to match users with appropriate content. In another embodiment, the system 300 is also configured to allow users to rate the content that is utilized and to modify the profile information for both the users and the content. In one example, the content utilized by the user is an advertisement. In this example, the distribution of the advertisement is targeted based on the profile of the user. Further, the distribution of the advertisement is tracked to specific users which in turn are able to rate the advertisement in one embodiment. Based on the rating of the advertisement and the profile information of the user, the system 300 is capable of distributing the advertisement to additional users.

In another embodiment, the system 300 is configured to allow an original user to directly forward the content to another user.

The system 300 in FIG. 3 is shown for exemplary purposes and is merely one embodiment of the methods and apparatuses for distributing content based on profile information and rating the content. Additional modules may be added to the system 300 without departing from the scope of the methods and apparatuses for distributing content based on profile information and rating the content. Similarly, modules may be combined or deleted without departing from the scope of the methods and apparatuses for distributing content based on profile information and rating the content.

FIG. 4a illustrates a simplified record 400 that corresponds to a profile that describes a specific content. In one embodiment, the record 400 is stored within the storage module 330 and utilized within the system 300. In one embodiment, the record 400 includes a content identification field 405, a content description field 410, a key terms field 415, an average time field 420, and a history field 425.

In one embodiment, the content identification field 405 identifies a specific content associated with the record 400. In one example, the content's name is utilized as a label for the content identification field 405.

In one embodiment, the content description field 410 includes a description of the content. In one example, if the content is a commercial for snowboarding equipment, then the content description field 410 may include a detailed written description of this commercial indicating attributes of the commercial such as the location where the commercial was shot, the product names, description of the scenery, and the like. For example in a snowboarding equipment commercial, the words “snow”, “winter sports”, “snowboarding”, “cold”, “winter”, and the like may be utilized within the content description field 410.

Different levels of details may be included within the content description field 410. In one embodiment, a narrative or summary of the content may be included within the content description field 410.

In one embodiment, the key terms field 415 identifies select terms that characterize the content. In one embodiment, key terms include terms that identify the content type such as music, television, commercials, talk radio, and the like. In another embodiment, within the music category, the types of content may be further distinguished by types of music such as rock, classical, jazz, heavy metal, and the like.

In one embodiment, the average time field 420 identifies an average time that a viewer spends on the content. In another embodiment, the average time field identifies the amount of time that each viewer spends on the content.

In one embodiment, the history field 425 identifies the viewers that have utilized the content. In one embodiment, the history field 425 also identifies when the viewers utilized the content.

FIG. 4b illustrates a simplified record 450 that corresponds to a profile that describes a specific user. In one embodiment, the record 450 is stored within the storage module 330 and utilized within the system 300. In one embodiment, the record 450 includes a user identification field 455, a content preference field 460, a subject preference field 465, a content history field 470, a content referral field 475, and a related users field 480.

In one embodiment, the user identification field 455 identifies a specific user associated with the record 450. In one example, the user's name is utilized as a label for the user identification field 455.

In one embodiment, the content preferences field 460 includes a description of the content that is preferred by the user. In one embodiment, the content preferences field 460 includes type of content that is preferred by the user such as music, television, commercials, talk radio, and the like. In another embodiment, within the music category, the types of content may be further distinguished by types of music such as rock, classical, jazz, heavy metal, and the like.

Further, the content preferences field 460 may also include the length of content preferred by the user in one embodiment. Different levels of details may be included within the content preferences field 460.

In one embodiment, the subject preferences field 465 identifies subjects that are of interest to the user. In one embodiment, subjects such as sports, football, snowboarding, and cooking may be included within the subject preferences field 465 as interests by the user.

In one embodiment, the content history field 470 identifies content that is utilized by the user. In another embodiment, the content history field 420 also identifies the time that the user spends on the content. In one embodiment, the content history field 420 may be utilized to refine and change the content preferences field 460 and the subject preferences field 465.

In one embodiment, the content referral field 475 identifies the content that is referred to the user and also identifies the content referred by the user.

In one embodiment, the related users field 480 identifies other users that are connected with the identified user within the user identification field 455.

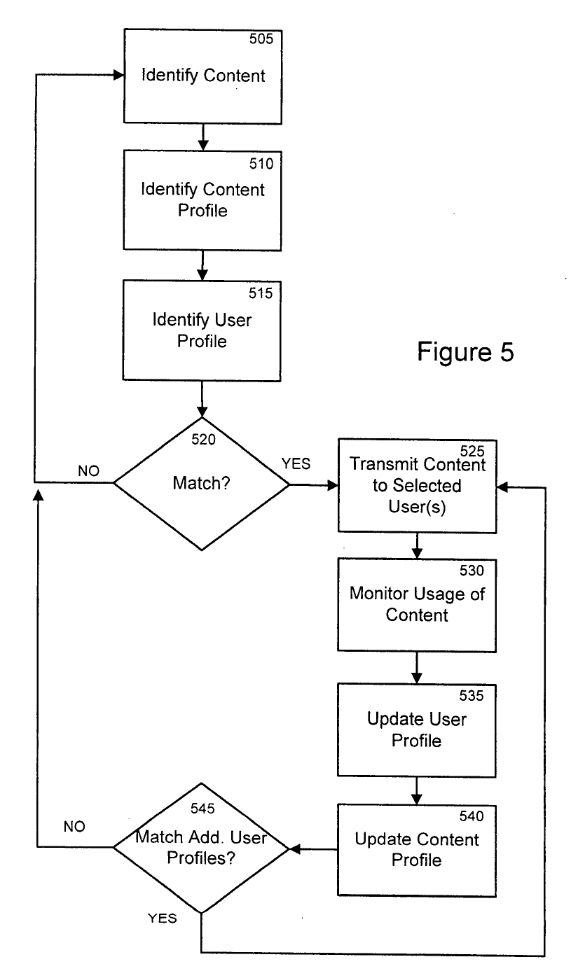

The flow diagram as depicted in FIG. 5 is one embodiment of the methods and apparatuses for distributing content based on profile information and rating the content. The blocks within the flow diagram can be performed in a different sequence without departing from the spirit of the methods and apparatuses for distributing content based on profile information and rating the content. Further, blocks can be deleted, added, or combined without departing from the spirit of the methods and apparatuses for distributing content based on profile information and rating the content.

The flow diagram in FIG. 5 illustrates transmitting and tracking content according to one embodiment of the invention.

In Block 505, content is identified. In one embodiment, specific content such as a television show is detected and identified. In one embodiment, the specific content may be selected from a plurality of content. Further, the plurality of content may include multiple types of content such as television shows, video, commercials, radio programming, music, and the like. In one embodiment, the plurality of content is stored within the storage module 330.

In Block 510, a content profile corresponding with the identified content within the Block 505 is identified. An exemplary content profile is illustrated as record 400 within FIG. 4a.

In Block 515, a user profile is identified that corresponds with a user. In another embodiment, a plurality of user profiles is identified. An exemplary user profile is illustrated as record 450 within FIG. 4b.

In Block 520, a match is performed between the content profile as identified within the Block 510 and the user profile as identified within the Block 515. In one embodiment, the content description field 410 within the record 400 is matched with the content preferences field 460 and subject preferences field 465 within the record 450. Further, the key terms field 415 within the record 400 is matched with the content preferences field 460 and subject preferences field 465 within the record 450 in another embodiment.

In embodiment, a match between the content profile and the user profile may be determined through a match threshold that finds satisfies a minimum level of matching to proceed. In one embodiment, the rating module 370 determines the match between the content profile and the user profile.

If there is no match, then additional content is detected within the Block 505.

If there is a match, then the identified content from the Block 505 is transmitted to the identified user associated with the matched user profile within Block 525.

In Block 530, usage of the identified content by the identified user is monitored. In one embodiment, the amount of time the user utilizes the content is monitored. In another embodiment, the user's reaction to the content is also monitored. The user's reactions include direct input to rate the content, indirect factors such as laughter, frowns, smiles, and the like.

In Block 535, the user profile associated with the identified user is updated. In one embodiment, the content preferences field 460 and subject preferences field 465 are updated to include additional terms based on the length of time the identified content is utilized by identified user or the user's reactions to the content. For example, if the identified content includes subject matter related to “water skiing” and the identified user utilizes this identified content for a lengthy period of time or provides a direct or indirect positive rating to the content, then the content preferences field 460 and subject preferences field 465 are modified to include the term “water skiing”. In another embodiment, the actual content identifier may be included within the content preferences field 460 and the subject preferences field 465.

In one embodiment, the content history field 470 is updated to include the identified content as part of the content history for the identified user.

In one embodiment, the content referral field 475 is updated to include targeted users that are transmitted the identified content. In one embodiment, the targeted users are derived from the related users field 480.

In Block 540, the content profile associated with the identified content is updated. In one embodiment, the average time field 420 is updated based on the average amount of time that identified users utilize the content. In one embodiment, the history field 425 is updated based on the identified users that are transmitted the content within Block 525.

In Block 545, a match is performed between a content profile identified within the Block 510 and a user profile associated with an additional user. In one embodiment, the additional user is identified through the related users field 480 of the record 450. In one embodiment, the related users field 480 is associated with the user profile identified within the Block 515. In another embodiment, the related users field 480 is associated with the user profile that had a sufficient match within the Block 520.

In one embodiment, the content description field 410 within the record 400 is matched with the content preferences field 460 and subject preferences field 465 within the record 450. Further, the key terms field 415 within the record 400 is matched with the content preferences field 460 and subject preferences field 465 within the record 450 in another embodiment.

In embodiment, a match between the content profile and the user profile may be determined through a match threshold that finds satisfies a minimum level of matching to proceed. In one embodiment, the rating module 370 determines the match between the content profile and the user profile.

In another embodiment, the user utilizing the content within the Block 525 may explicitly refer the content to another user regardless of the match performed within the Block 545. In this instance, the content is transmitted to the explicitly referred user within the Block 525.

If there is no match within the Block 545, then additional content is detected within the Block 505.

If there is a match within the Block 545, then in the Block 525 the identified content from the Block 505 is transmitted to the identified user associated with the matched user profile from the related users field 480.

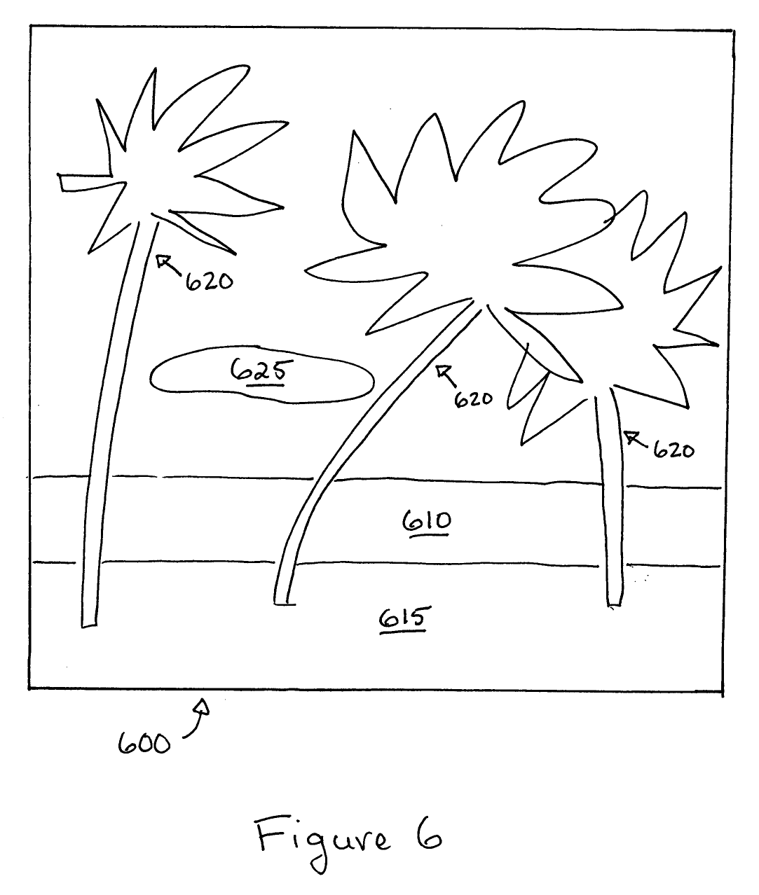

FIG. 6 illustrates an exemplary portion of the content for use with the system 300. In one embodiment, a screen shot 600 displays an exemplary portion of the content. In one embodiment, the screen shot 600 displays an ocean 610, a beach 615, palm trees 620, and clouds 625.

In one embodiment, the elements included within the screen shot 600 may be represented by the record 400 as a content profile. For example, the content identification field 405 may include a reference to a “beach scene”. Further, the content description field 410 and the key terms field 415 may include references that include the elements “ocean”, “beach”, “palm trees”, and “clouds”.

In one embodiment, by having a description of the content, users are able to be matched with content that is interesting and applicable to the user. Further, a user profile as described within the record 450 is able to be refined to more fully reflect the tastes and interests of the user based on the ratings assigned to the content by the user.

For example, the content preferences field 460 and the subject preferences field 465 can have terms added or deleted depending on the ratings assigned by the user for specific content. In this instance, if the user were to rate the screen shot 600 highly, then the terms “ocean”, “beach”, “palm trees”, and “clouds” may be added to the content preferences field 460 and the subject preferences field. Similarly, if the user were to rate the screen shot 600 poorly, then the terms “ocean”, “beach”, “palm trees”, and “clouds” may be deleted from the content preferences field 460 and the subject preferences field.

In one embodiment, the owner of the content may track the use of the content by other users through the content profile as represented by the record 400. In one embodiment, the content owner may track the effectiveness of the content while being utilized by the content users. Further, the content owner may also track the distribution of the content to other users.

The foregoing descriptions of specific embodiments of the invention have been presented for purposes of illustration and description. For example, the invention is described within the context of for distributing content based on profile information and rating the content as merely one embodiment of the invention. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting content and content information wherein the content information is related to the content;
detecting a user and user information wherein the user information is related to the user;
matching the content information with the user information;
selecting the user based on the matching;
detecting a user input based on the user utilizing the content; and
modifying the user information and the content information based on the user input.

2. The method according to claim 1 wherein the content information is metadata describing the content.

3. The method according to claim 1 wherein the user information is metadata describing the user.

4. The method according to claim 1 wherein the content information includes one of a content description field, a key terms field, an average time field, and a history field.

5. The method according to claim 1 wherein the user information includes one of a content preferences field, a subject preferences field, a content history field, a content referral field, and a related users field.

6. The method according to claim 1 the user input includes one of a direct input and an indirect input.

7. The method according to claim 6 wherein the direct input includes an explicit input to indicate a rating of the content

8. The method according to claim 6 wherein the direct input is performed though one of a keyboard and a pointing device.

9. The method according to claim 6 wherein the indirect input includes an implicit input that suggests a rating of the content.

10. The method according to claim 6 wherein the implicit input includes sound detection, length of time spent on the content.

11. The method according to claim 1 further comprising storing the user information within a profile.

12. The method according to claim 1 further comprising storing the content information within a profile.

13. The method according to claim 1 wherein the content is one of: an audio stream, an image, a video stream, a photograph, a graphical file, a text file, a software application, and an electronic message.

14. The method according to claim 1 further comprising modifying the user information further comprises adding a term to one of a content preferences field and a subject preferences field.

15. The method according to claim 1 further comprising modifying the user information further comprises deleting a term from one of a content preferences field and a subject preferences field.

16. The method according to claim 1 further comprising transmitting the content to the user.

17. A system, comprising:
a content detection module configured for detecting content and content information relating to the content;
a user detection module configured for detecting user information relating to a user and detecting a response from the user based on the content;
a rating module configured to match the content with the user based on the content information and the user information; and
a profile module configured for modifying the user information based on the response from the user.

18. The system according to claim 17 wherein the content information includes a content profile that includes one of a content description field, a key terms field, an average time field, and a history field.

19. The system according to claim 17 wherein the content information is metadata describing the content.

20. The system according to claim 17 wherein the content is one of: an audio stream, an image, a video stream, a photograph, a graphical file, a text file, a software application, and an electronic message.

21. The system according to claim 17 wherein the user information includes a user profile that includes one of a content preferences field, a subject preferences field, a content history field, a content referral field, and a related users field.

22. The system according to claim 17 wherein the user information is metadata describing the user.

23. The system according to claim 17 further comprising a storage module configured for storing the content, the content information, and the user information.

24. The system according to claim 17 further comprising a content tracking module configured for tracking a location of the content based on a match within the rating module.

25. The method according to claim 17 wherein the response reflects a direct rating of the content through one of a keyboard input and a pointing device input.

26. The method according to claim 17 wherein the response reflects an indirect rating of the content through one of an audible response, a visual response, and a length of time utilizing the content.

27. A computer-readable medium having computer executable instructions for performing a method comprising:
detecting content and content information wherein the content information is related to the content;
detecting a user and user information wherein the user information is related to the user;
matching the content information with the user information;
selecting the user based on the matching;
detecting a user input based on the user utilizing the content; and
modifying the user information and the content information based on the user input.
